(19) United States
(12) Patent Application Publication
(10) Pub. No.: US 2018/0208224 A1
(43) Pub. Date: Jul. 26, 2018

(54) SHOPPING CART ITEM SECURING DEVICE

(71) Applicants: Patricia Hennessy, Dublin, NH (US); Dana Hennessy, Dublin, NH (US); Maurice Glaude, Francestown, NH (US); Carrie Glaude, Francestown, NH (US)

(72) Inventors: Patricia Hennessy, Dublin, NH (US); Dana Hennessy, Dublin, NH (US); Maurice Glaude, Francestown, NH (US); Carrie Glaude, Francestown, NH (US)

(21) Appl. No.: 15/924,981

(22) Filed: Mar. 19, 2018

Related U.S. Application Data
(63) Continuation-in-part of application No. 15/588,038, filed on May 5, 2017.
(60) Provisional application No. 62/332,498, filed on May 6, 2016.

(51) Int. Cl. B62B 3/14

(52) U.S. Cl. CPC B62B 3/146

(57) ABSTRACT

A shopping cart attachment for attaching items to a shopping cart. The shopping cart attachment includes a housing with a top end and a bottom end. The top end includes a first latching member and a first upward facing C-shape. The bottom end includes a first downward facing C-shape. A clasp includes a second downward facing C-shape having a first end pivotally attached to the top end of the housing, and a second end having a second latching member releasably connected to the first latching member. A first screw and a second screw are coupled to the bottom end of the housing. A clamp includes a second upward facing C-shape having a first end connected to the housing by the first screw and a second end having an open faced slot sized to receive the second screw.

### CROSS-REFERENCE TO RELATED APPLICATION

This application is a continuation in part of U.S. non-provisional application Ser. No. 15/588,038, filed May 5, 2017, which claims the benefit of priority of U.S. provisional application No. 62/332,498, filed May 6, 2016, the contents of which are herein incorporated by reference.

### BACKGROUND OF THE INVENTION

The present invention relates generally to shopping cart accessories. More particularly the present invention relates to a device configured to secure a purse or bag handle to the shopping cart.

### SUMMARY OF THE INVENTION

In one aspect of the present invention, a shopping cart attachment comprises: a housing comprising a top end and a bottom end, wherein the top end comprises a first latching member and a first upward facing C-shape and the bottom end comprises a first downward facing C-shape having a first end and a second end; a clasp comprising a second downward facing C-shape having a first end pivotally attached to the top end of the housing, and a second end comprising a second latching member releasably connected to the first latching member; a first screw coupled to the first end of the bottom end of the housing and a second screw coupled to the second end of the bottom end of the housing; and a clamp comprising a second upward facing C-shape having a first end connected to the housing by the first screw and a second end comprising an open faced slot sized to receive the second screw.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use in a closed configuration;

FIG. 2 is an exploded view of an embodiment of the present invention; and

FIG. 3 is section detail view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Generally, the present invention concerns a device for securing items to a shopping cart. The device can be attached to a shopping cart on one end, and to an item to be secured at the other end. The device may comprise: a trip mechanism to automatically close the device over the item to be secured; a push button to open the device; a band or other structure to clasp to the shopping cart—such as at a handlebar; and screws or other connection devices to tighten the band around the cart's handlebar.

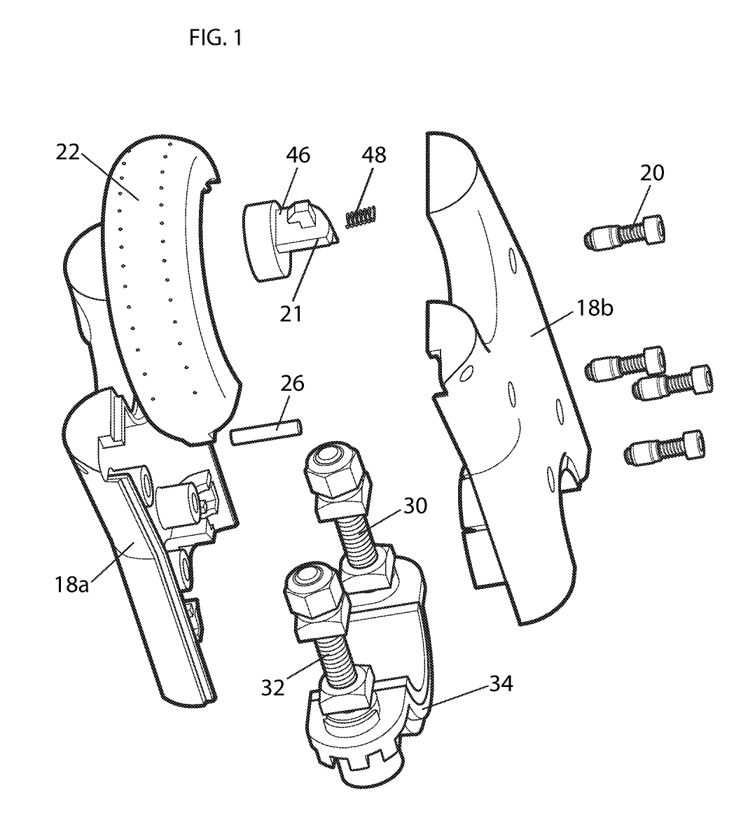

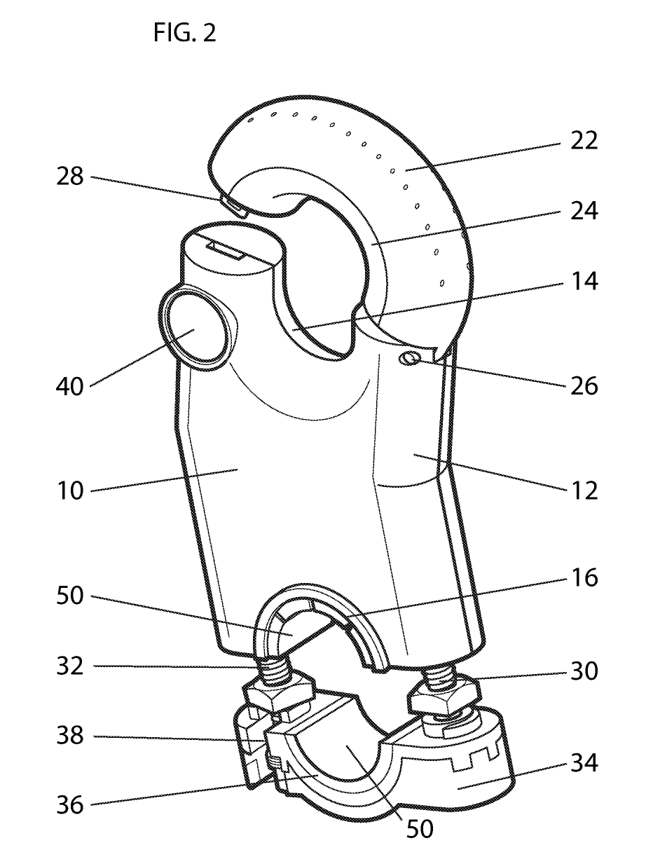

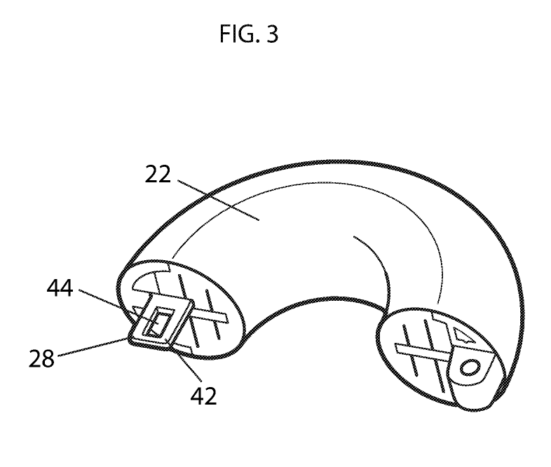

Referring to FIGS. 1 through 3, the present invention includes a shopping cart attachment 10. The shopping cart attachment 10 includes a housing 12. The housing 12 has a top end and a bottom end. The top end includes a first latching member 21 and a first upward facing C-shape 14. The bottom end includes a first downward facing C-shape 16. A clasp 22 includes a second downward facing C-shape 24 having a first end pivotally attached to the top end of the housing 12 by a pivot pin 26, and a second end having a second latching member 28 releasably connected to the first latching member 21. A first screw 30 is coupled to a first end of the bottom end of the housing 12 and a second screw 32 is coupled to the second end of the bottom end of the housing 12. A clamp 34 includes a second upward facing C-shape 36 having a first end connected to the housing by the first screw 30 and a second end having an open faced slot 38 sized to receive the second screw 32.

The shopping cart attachment 10 includes an open clamp configuration and a closed clamp configuration. The open clamp configuration includes the clamp 34 pivoting about a longitudinal axis of the first screw 30 with the second screw 32 outside of the open faced slot 28. The clamp 34 may rotate up to 360 degrees relative to the housing 12. The closed clamp configuration includes the second screw 32 disposed within the open faced slot 38. Tightening the screws 30, 32 in the closed clamp configuration urges the second upward facing C-shape 36 towards the first downward facing C-shape 16, clamping the housing 12 to a structure therebetween. The screws 30, 32 may be tightened by a Philips head, Alan wrench, flat head and the like.

The housing 10 may be a molded two piece structure including a first section 18a and a second section 18b. The first section 18a and the second section 18b fit together. The second section 18b may include openings formed therethrough. The first section 18a may include internal threaded openings that align with the openings of the second section 18b. Bolts 20 may run through the aligned openings and mechanically fasten to the threaded openings, thereby connecting the first section 18a and the second section 18b together.

In certain embodiments, the present invention may include a push button 40 operably connected to the first latching member 21. Engaging the push button 40 disengages the first latching member 21 from the second latching member 28, allowing the clasp 22 to pivot freely upward about the pivot pin 26. In certain embodiments, the second latching member 28 includes an insert 42 protruding from the clasp 22. The insert 42 includes a lock opening 44. The first latching member 21 includes a sliding jaw 46 disposed within the housing 12. The sliding jaw 46 is biased by a spring 48 to engage the insert 42 by at least partially being disposed within the lock opening 44. When the push button 40 is engaged, the sliding jaw 46 laterally slides away from the insert 42 against the bias of the spring 48 and out of the lock opening 44, thereby disengaging the second end of the clasp 22 from the housing 12.

The present invention may further include a padding 50. The padding 50 may be made of a compressible material, such as foam, silicone, rubber and the like. The padding 50 is attached to the inner surfaces of the first downward facing C-shape 16 and the second upward facing C-shape 36. The padding 50 prevents the housing 12 from rotating relative to a structure in which the housing 12 is clamped to.

A method of using the present invention may include the following. A user may first convert the shopping cart attachment 10 from the closed clamp configuration to the open clamp configuration. The user may do so by loosening the first screw 30 and the second screw 32 and then rotating the clamp 34 about the longitudinal axis of the first screw 30, thereby removing the second screw 32 from the open faced slot 38. The user may then place a handlebar of a shopping cart in between the first downward facing C-shape 16 and the second upward facing C-shape 36. The user then converts the shopping cart attachment 10 from the open clamp configuration to the closed clamp configuration by rotating the clamp 34 back so that the second screw 32 is disposed within the open faced slot 38. The screws 30, 32 are then tightened in the closed clamp configuration, which urges the second upward facing C-shape 36 towards the first downward facing C-shape 16, clamping the housing 12 to the handlebar of the shopping cart. The user may then press the push button 40, disengaging the first latching member 21 from the second latching member 28. The user may pivot the clasp 22 upwards and away from the housing 12, thereby opening the clasp 22. The user may then place their purse handle or other bag handle on the first upward facing C-shape 14 of the housing 12 and pivot clasp 22 back towards the housing 12. The second latching member 28 may snap onto the first latching member 21, locking the clasp 22 to the housing 12. The purse or other bag is now releasably secured to the shopping cart while the user is shopping.

It should be understood, of course, that the foregoing relates to exemplary embodiments of the invention and that modifications may be made without departing from the spirit and scope of the invention as set forth in the following claims.

What is claimed is:

1. A shopping cart attachment comprising:
a housing comprising a top end and a bottom end, wherein the top end comprises a first latching member and a first upward facing C-shape and the bottom end comprises a first downward facing C-shape having a first end and a second end;
a clasp comprising a second downward facing C-shape having a first end pivotally attached to the top end of the housing, and a second end comprising a second latching member releasably connected to the first latching member;
a first screw coupled to the first end of the bottom end of the housing and a second screw coupled to the second end of the bottom end of the housing; and
a clamp comprising a second upward facing C-shape having a first end connected to the housing by the first screw and a second end comprising an open faced slot sized to receive the second screw.

2. The shopping cart attachment of claim 1, wherein the shopping cart attachment comprises an open clamp configuration and a closed clamp configuration, wherein the open clamp configuration comprises the clamp pivoting about a longitudinal axis of the first screw and the closed clamp configuration comprises the second screw disposed within the slot, wherein tightening the screws in the closed clamp configuration urges the second upward facing C-shape towards the first downward facing C-shape.

3. The shopping cart attachment of claim 1, further comprising a push button operably connected to the first latching member, wherein engaging the push button disengages the first latching member from the second latching member.

4. The shopping cart attachment of claim 3, wherein the second latching member comprises an insert protruding from the clasp, wherein the insert comprises a lock opening, and the first latching member comprises a sliding jaw disposed within the housing and biased to engage the insert to be at least partially disposed within the lock opening, wherein the push button is operable to laterally slide the sliding jaw away from the insert and out of the lock opening, thereby disengaging the second end of the clasp from the housing.

5. The shopping cart attachment of claim 1, further comprising a padding attached to the inner surfaces of the first downward facing C-shape and the second upward facing C-shape.
